(19) United States
(12) Patent Application Publication
(10) Pub. No.: US 2008/0166202 A1
(43) Pub. Date: Jul. 10, 2008

(54) Conical nut

(76) Inventors: William L. Dunlap, Elkhart, IN (US); Daniel W. Bard, Middlebury, IN (US)

Correspondence Address: DEXTER AXLE COMPANY, C/O THE GATES CORPORATION, IP LAW DEP 10-A3 1551 WEWATTA STREET, DENVER, CO, 80202, US

(21) Appl. No.: 11/650,685

(22) Filed: Jan. 8, 2007

(51) Int. Cl. F16B 43/00

(52) U.S. Cl. 411/353

(57) ABSTRACT

A conical nut comprising a body (10) having a cylindrical portion (121), a threaded bore surface (13) and a flange (11) extending normally from the cylindrical portion, a biasing member comprising a disc spring (30), a conical seat (450) having a tapered surface (451), the conical seat coaxially engagable with the cylindrical portion, the biasing member disposed between the flange and the conical seat, and a flared rim (120) engaged with the conical seat (450) to prevent disengagement of the conical seat from the cylindrical portion.

### FIELD OF THE INVENTION

The invention relates to a conical nut, and more particularly, to a conical wheel nut having a conical seat that is engaged with a nut by a shank rim.

### BACKGROUND OF THE INVENTION

A common problem encountered by freight haul tractor trailers, as well as smaller trailers used for non-commercial purposes such as recreational trailers, is the loosening of the lug nuts on the wheels of the trailer.

A common problem results from methods used to secure nuts to lug bolts on new truck and trailer wheels. Unless properly addressed “seating-in” during initial use can result in a reduction of the clamp force, and thereby the torque, which holds the wheel to the axle hub. This can over time create a gap between the nut and the wheel which enables the initially tight nuts to loosen up.

Further, the stacking of components on a vehicle wheel hub creates a cumulative thickness of the stacked parts. The initial torque can force the material of the stacked components to yield, thereby allowing the nuts to loosen by “bleeding off” the initial torque and preload, again, causing the nut to loosen.

Loss of torque can also occur as a result of long storage periods where the wheel assembly is subjected to repeated cycles of heating and cooling.

Once the nuts have loosened, the wheel is able to rock and wobble back and forth on the lug bolts. After a period of time, the lug hole diameter in the wheel can be significantly enlarged, damaging the wheel as well as severely degrading the stability of the trailer, rending it uncontrollable. Also, relative movement of the wheel can result in fatigue failure of the lug bolts, causing catastrophic separation of the wheel from the axle hub. For example, in an emergency or panic stop, once loosened under hard application of the brakes the wheel can shear off the lug bolts, thus rendering the trailer or vehicle uncontrollable. Once detached the wheel can become a dangerous projectile as well, capable of seriously injuring others.

This situation can be further aggravated by the accumulation of debris on the various engaged, load bearing surfaces of the lug nut system.

Representative of the art is U.S. Pat. No. 5,827,025 (1998) to Henriksen which discloses a self-tensioning, disc spring assembly. The assembly has a circular disc spring with an outer diameter and an inner diameter defining a center hole. The disc spring has a height greater at the inner diameter than at the outer diameter. The disc spring is also resiliently compressible such that it can be flattened. A zinc element, being zinc or a zinc alloy, is provided in the form of a ring or other shape, or a surface deposit on the disc spring or nut, to prevent rusting of the lug bolt.

Reference is also made to copending U.S. non-provisional application Ser. No. 11/263,004 filed Oct. 31, 2005.

What is needed is a conical wheel nut having a conical seat that is engaged with a nut by a flared shank rim. The present invention meets this need.

### SUMMARY OF THE INVENTION

The primary aspect of the invention is to provide a conical wheel nut having a conical seat that is engaged with a nut by a flared shank rim.

Other aspects of the invention will be pointed out or made obvious by the following description of the invention and the accompanying drawings.

The invention comprises a conical nut comprising a body having a cylindrical portion, a threaded bore surface and a flange extending normally from the cylindrical portion, a biasing member comprising a disc spring, a conical seat having a tapered surface, the conical seat coaxially engagable with the cylindrical portion, the biasing member disposed between the flange and the conical seat, and a flared rim engaged with the conical seat to prevent disengagement of the conical seat from the cylindrical portion.

### BRIEF DESCRIPTION OF THE DRAWINGS

The accompanying drawings, which are incorporated in and form a part of the specification, illustrate preferred embodiments of the present invention, and together with a description, serve to explain the principles of the invention.

FIG. 1 is a perspective view of the conical nut.

FIG. 2 is a cross-section view of the conical nut.

FIG. 3 is an end view of the conical nut.

FIG. 4 is a side view of the conical nut.

FIG. 5 is an end view of the conical nut.

FIG. 6 is a detail of FIG. 2.

FIG. 7 is a cross-sectional view of the conical nut on a wheel and hub.

FIG. 8 is a chart showing total wheel tension for the conical nut compared to prior art nuts.

### DETAILED DESCRIPTION OF THE PREFERRED EMBODIMENT

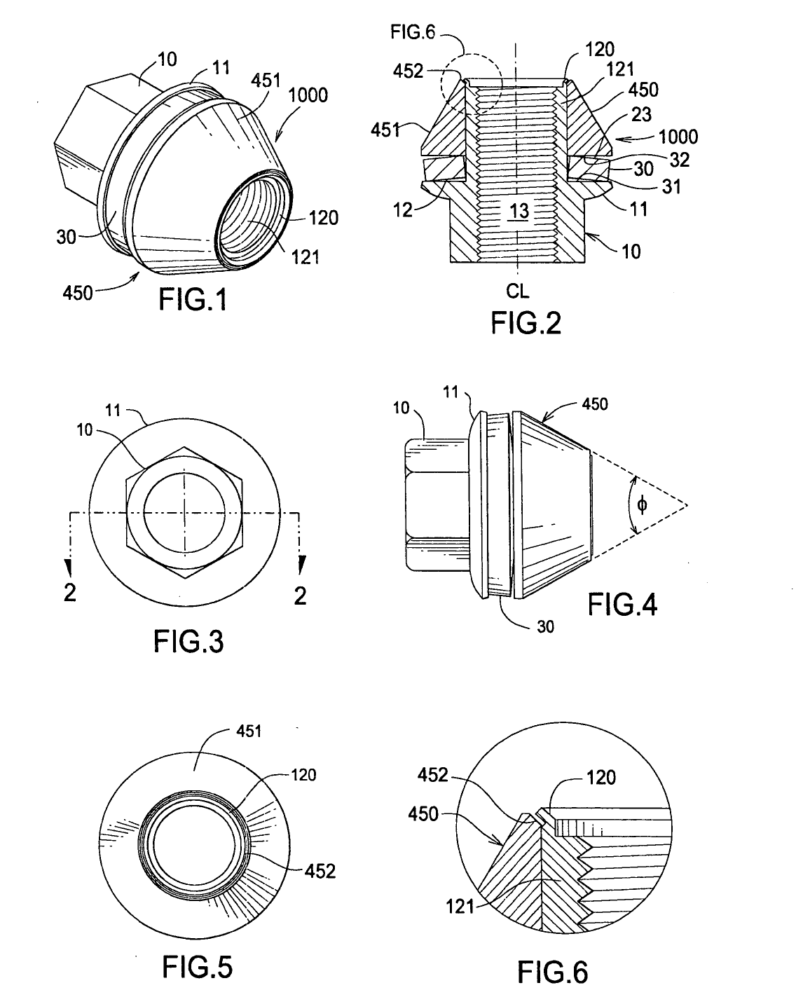

FIG. 1 is a perspective view of the conical nut. Embodiment 1000 comprises nut 10 and disc spring 30. Disc spring 30 and conical seat 450 are coaxially engaged about a shank 121.

Conical seat 450 comprises a surface 451 having a cone angle φ (FIG. 4) creating a tapered surface 451. Cone angle φ may be in the range of approximately 60° to approximately 90°. In the preferred embodiment angle φ is approximately 60°.

Disc spring 30 is disposed between flange 11 and conical seat 450. Disc spring 30 is also referred to as a Belleville spring, known in the art. Surfaces 12, 23 extend substantially normal to a conical nut centerline CL. In the case where disc spring 30 is present each surface 12, 23 slides upon respective surfaces 31, 32 of disc spring 30. In an alternate embodiment where disc spring 30 is not present surfaces 23 and 12 slide directly upon each other as nut 10 is torqued down on a stud.

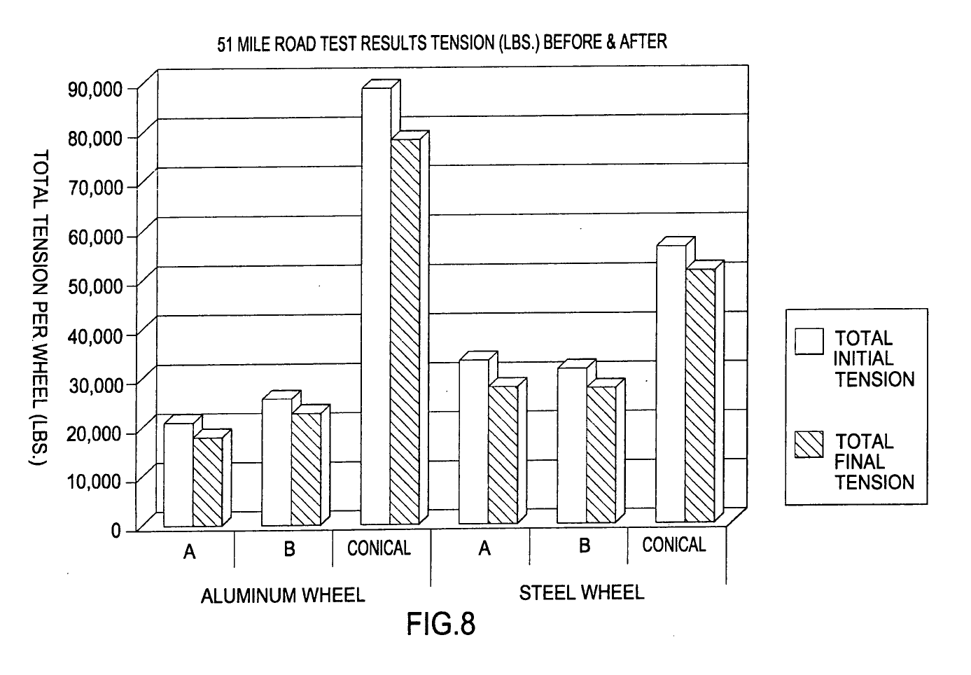

During installation only nut 10 is rotated about stud 400. Conical seat 450 does not rotate with respect to stud 400 or wheel 200 once seat 450 engages wheel 200. Since the forces acting on surfaces 12, 23 to preload stud 400 are substantially normal to surfaces 12, 23, the frictional force generated between surfaces 12, 23 and disc spring 30 is substantially less than compared to a prior art single piece nut wherein a tapered nut surface is directly engaged with a wheel (FIG. 8). In turn, a greater percentage of the torque applied to the inventive conical nut during installation goes into preloading stud 400 instead of being used to overcome friction between surface 451 and the wheel 200. This in turn results in a significantly greater clamp force applied to the wheel since the stud preload is greater for a given torque. Preload L is a desired design preload in the stud or bolt. The desired stud preload L is achieved by application of the installation torque on the nut 10. Each of these concepts is well known in the mechanical arts. Selection of the proper stud preload assures the proper clamp load for the conical nut 1000 and retention of the wheel on a hub.

The following table is offered to illustrate a range of approximate torque values that are based upon the diameter of the stud 400. These figures are only offered by way of example and are not intended to limit the application of the inventive conical nut.

| Stud Diameter | Torque Range |
|---|---|
| ½″ | ~60 to ~120 ft/lbs |
| 9/16″ | ~90 to ~170 ft/lbs |
| ⅝″ | ~190 to ~325 ft/lbs |

In an example system, a set of conical nuts are each torqued down on a ½″ stud to mount a wheel on a trailer hub. The number of studs/conical nuts utilized per wheel can include any appropriate number including but not limited to 4, 5, 6 or 8. The torque in this example system is approximately 120 ft lbs and the clamp force between each conical nut and the hub in this example is approximately 15,000 pounds. The proper clamp force prevents the wheel from moving about on the hub during operation. If the clamp force is too low the wheel will move about on the hub causing a periodic bending moment to be imposed on the studs. The periodic bending moment may ultimately cause the studs to fail.

The desirable characteristic of the conical nut has the effect of enhancing and maintaining the proper clamping force between the conical nut and the wheel. The clamping force assures that the wheel does not move about on the hub and that the load on each stud 400 is a tensile load acting axially on each stud. This is in contrast to a periodic bending moment caused by a “loose” wheel nut which can result if the clamping force is not sufficient, again, potentially leading to premature failure of the stud.

For example, unintended partial rotation of nut 10 may occur during operation if a flat of the nut is struck by a piece of debris. Temperature changes or repeated strikes might otherwise further loosen the nut, but, the disc spring 30 enhances the ability of the nut to maintain proper preload on the stud or bolt. Mechanical yielding by the components may also cause torque to bleed off as well, but such torque bleed is prevented by use of the disc spring 30.

With respect to disc spring 30, Belleville springs demonstrate known and predictable characteristics in compression. Proper selection allows a predetermined stud load to be substantially constant over a significant spring deflection range. A preload for a given deflection can be adjusted by stacking two or more of springs 30.

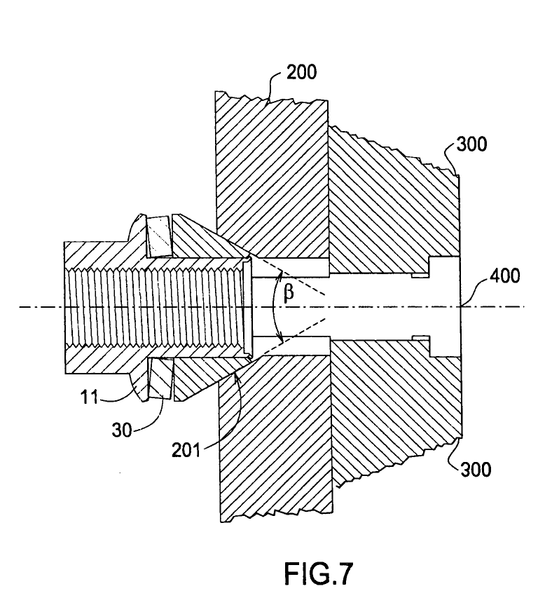

FIG. 2 is a cross-sectional view of the conical nut. Flange 11 radially extends from nut 10. Internal bore surface 13 of nut 10 is threaded to engage a threaded bolt or stud. A stud is a component of a vehicle wheel hub, such as on a trailer axle, see FIG. 7. However, it should be noted that the inventive conical nut may be used in any suitable application requiring a reliable threaded connection.

Conical seat 450 comprises surface 452. Rim 120 is slightly radially flared to mechanically engage surface 452 in order to keep conical seat 450 connected to nut 10. Conical seat 450 may rotate about shank 12 but cannot axially disengage from nut 10 due to rim 120.

FIG. 3 is an end view of the conical nut. The hex form of nut 10 is readily engagable with known wrenches and sockets.

FIG. 4 is a side view of the conical nut. A single disc spring 30 is shown on this embodiment, although use of two or more disc springs in series is possible depending upon the desired spring rate. Disc spring 30 may also be replaced with a simple flat washer known in the art. Cone angle φ is in the range of approximately 60° to approximately 90°. In an alternate embodiment disc spring 30 is omitted.

FIG. 5 is an end view of the conical nut. Rim 120 is flared radially outward to engage conical seat surface 452.

FIG. 6 is a detail of FIG. 2. Conical seat 450 comprises surface 452 which is machined, stamped or otherwise flared radially. The shape of surface 452 is a conical section. Flared shank rim 120 extends from shank 121. Shank rim 120 is somewhat thinner than shank 121 because rim 120 must be subject to being bent or flared outward. For example, rim 120 may be flared using a swage machine or equivalent equipment known in the art. Rim 120 slidingly engages surface 452. Shank 121 otherwise has a thickness sufficient to properly torque to a stud 400.

Flared rim 120 creates a mechanical engagement between nut 10 and conical seat 450 whereby the two are rotationally connected together. The engagement between the conical seat 450 and nut 10 must be loose enough to allow the conical seat 450 to freely rotate about nut shank 121 while preventing the nut and conical seat from disengaging or separating during storage or use.

FIG. 7 is a cross-sectional view of the nut on a wheel and hub. Stud 400 is connected to and extends from hub 300, each known in the art. Wheel 200 comprises one or more wheel flange holes having surfaces 201, each of which engages a stud 400. Wheel 200 is clamped to hub 300 by nuts 10.

Surface 451 of conical seat 450 comprises a cone angle φ to properly engage a wheel flange hole surface 201. Wheel flange hole surface 201 has a seat angle β which cooperates with surface 451. Conical seat 450 automatically aligns with a wheel flange hole surface 201 during installation. Cone angle φ substantially matches the seat angle β to assure proper engagement of surface 201 with surface 451.

FIG. 8 is a chart showing total wheel tension for the conical nut compared to prior art nuts. The chart shows the stud tension, or clamp force, generated by conical nuts as well as two other prior art nuts, “A” and “B”. Prior art nuts “A” and “B” are of a known single piece design wherein a tapered surface engages a tapered hole in the wheel. For comparison, all of the nuts are illustrated on an aluminum wheel and on a steel wheel. The torque applied to each nut is approximately 120 ft lbs. Each wheel comprises 5 nuts/studs.

The initial total tension is significantly greater for the conical nut pattern as compared to the other prior art nuts. The conical nut clamp force for the given torque (120 ft lbs) is approximately 87,000 lbs as compared to 25,000 lbs (“B”) and 20,000 lbs (“A”) on the aluminum wheel.

The conical nut clamp force for the given torque is approximately 55,000 lbs as compared to 31,000 lbs (“B”) and 32,000 lbs (“A”) on the steel wheel.

During installation each prior art nut “A” and “B” must overcome the friction created between the tapered nut surface and the wheel hole. The friction resisting the nut as it is turned is greater for each prior art nut than each conical nut. Hence, for each prior art nut a significant amount of the installation torque is “lost” to overcoming the friction which in turn reduces the clamp force that would otherwise be realized from each stud.

The characteristics of the conical nut may be further enhanced by applying a lubricant to any or all of surfaces 12, 23, 31, 32. The lubricant further reduces the frictional force between these surfaces which enhances the clamp force applied by each nut. The lubricant may comprise any known in the art such as graphite, oil or grease.

The chart also illustrates the tension change for each nut pattern after a road test of approximately 51 miles. The conical nut pattern compares favorably with the prior arts nuts in terms of exhibiting a minimal tension loss over the operating cycle.

Although a form of the invention has been described herein, it will be obvious to those skilled in the art that variations may be made in the construction and relation of parts without departing from the spirit and scope of the invention described herein.

We claim:

1. A conical nut comprising:
a body (10) having a cylindrical portion (121), a threaded bore surface (13) and a flange (11) extending normally from the cylindrical portion;
a biasing member comprising a disc spring (30);
a conical seat (450) having a tapered surface (451), the conical seat coaxially engagable with the cylindrical portion;
the biasing member disposed between the flange and the conical seat; and
a flared rim (120) engaged with the conical seat (450) to prevent disengagement of the conical seat from the cylindrical portion.

2. The conical nut as in claim 1, wherein the tapered surface further comprises an angle φ in the range of approximately 60° to approximately 90°.

3. The conical nut as in claim 1, wherein the body comprises a portion for engaging a tool.

4. The conical nut as in claim 1, wherein the rim projects from an end of the cylindrical portion (121).

5. The conical nut as in claim 1 further comprising:
a surface (23) on the conical seat having a sliding engagement with the biasing member, the surface extending normally with respect to a conical nut centerline; and
the biasing member having a sliding engagement with the flange.

6. The conical nut as in claim 5, wherein the flange further comprises a surface (12), which surface (12) engages the biasing member.
